(19) United States
(12) Patent Application Publication
(10) Pub. No.: US 2022/0370175 A1
(43) Pub. Date: Nov. 24, 2022

(54) Dental implant able to enhance stability

(71) Applicant: Ho Fung KWAN, New Taipei City (TW)

(72) Inventor: Ho Fung KWAN, New Taipei City (TW)

(21) Appl. No.: 17/522,308

(22) Filed: Nov. 9, 2021

(30) Foreign Application Priority Data
May 20, 2021 (TW) 110118244

(51) Int. Cl. A61C 8/00

(52) U.S. Cl. CPC A61C 8/0025; A61C 8/0078; A61C 2008/0084

(57) ABSTRACT

This invention discloses a dental implant able to enhance stability for solving the problem of insufficient support of prior arts. The dental implant of this invention includes: a first threaded section having a first diameter which decreases toward a free end of the first threaded section along a longitudinal axis; a second threaded section connected with the first threaded section and having a second diameter larger than the first diameter; a cut-in section obliquely extending from one end, away from the first threaded section, of the second threaded section outwards and having a tip with a feature of sharpness for cutting into an alveolar bone of a patent in a dental implant surgery; and a head section connected with the cut-in section for receiving a force to facilitate the dental implant to move into the alveolar bone. The dental implant of this invention can enhance preliminary and long-term stability.

### FIELD OF THE PRESENT INVENTION

This invention generally relates to a dental implant, and more particularly to a dental implant having a cut-in section for enhancing stability of the dental implant.

### BACKGROUND OF THE PRESENT INVENTION

There are two types of traditional dental implants, i.e. one-pieced and two-pieced dental implants. For the two-pieced dental implant, it includes an artificial tooth root and an abutment both of which are manufactured in advance and then combined together. As for the one-pieced dental implant, it is made of the same material and becomes an integral part which contains two portions (an artificial tooth root and an abutment).

When the two-pieced dental implant is utilized in a dental implant surgery, the artificial tooth root of the two-pieced dental implant is mounted and secured in an alveolar bone of a patent by rotating the screw of the artificial tooth root. One end of the artificial tooth root is then covered by gum of the patient to allow growth of the alveolar bone during the period of osseointegration so as to preliminarily secure the artificial tooth root. Subsequently, the gum will be cut open again to allow an abutment to be mounted on the end of the artificial tooth root. However, the support of the alveolar bone to the artificial tooth root is limited because the artificial tooth root is secured only by means of contact surface between the thread of the artificial tooth root and the alveolar bone but the contact area therebetween is small. Hence, preliminary stability of the dental implant is insufficient and even the dental implant surgery entirely fails.

On the other hand, when the one-pieced dental implant is utilized in a dental implant surgery, by directly rotating the thread of the artificial tooth root of the one-pieced dental implant, the artificial tooth root is mounted and secured in an alveolar bone of a patent while the abutment is partially or completely exposed outside the gum. Under such a circumstance, food in a oral cavity will collide with the abutment exposed outside the gum when the patient is chewing. Such collision will affect growth of the alveolar bone and osseointegration, resulting in insufficient preliminary stability of the dental implant. Hence, aforementioned problem about entire failure of the two-pieced dental implant in a dental implant surgery is even worse on the one-pieced dental implant.

Moreover, after the artificial tooth root which simply has thread is implanted into the alveolar bone and used for a period, bacteria will go deep into the alveolar bone along the thread and then result in the periodontal disease.

Furthermore, for the patient whose ossein is in a bad situation, if the artificial tooth root is secured just by means of contact surface between the thread of the artificial tooth root and the alveolar bone, not only will preliminary stability affect successful growth of the alveolar bone but also the artificial tooth root which may be originally stable will become loosen because the bite force of upper and lower teeth or other external force. Both of cases will lead to a whole failure of the dental implant surgery. Therefore there is a need to increase contact surface or contact positions between the artificial tooth root and the alveolar bone. Another condition for the patient is inclination of the alveolar bone. When the artificial tooth root is secured to the inclined alveolar bone, the abutment will face the interior or exterior of the oral cavity. Consequently, an artificial crown mounted on the abutment is also oriented the interior or exterior of the oral cavity. Such a problem will affect not only appearance of the patient's face but also occlusion between the artificial crown and opposite tooth. In order to solve this problem, a dentist may grind off front surface or rear surface of the abutment. However, such an approach will make the abutment thinner and thus decrease the support strength of the abutment.

Human standard of living is gradually improved so that dental implant surgery is gradually popularized. However, above-mentioned issues still exist in the field of dental implant for a long time. Therefore, there is a need for a dental implant which can enhance stability or whose orientation is adjustable so as to solve forgoing issues.

### SUMMARY OF THE PRESENT INVENTION

Accordingly, this invention relates to a dental implant able to enhance stability that is substantially intended to obviate one or more of the problems due to the limitations and disadvantages encountered in prior arts.

One object of this invention is to provide a dental implant which can enhance stability by increasing the number of contact positions or contact points between the dental implant and the alveolar bone.

Another object of this invention is to provide a dental implant which can enhance stability by increasing contact area between the dental implant and the alveolar bone.

Yet another object of this invention is to provide a dental implant which can enhance stability by increasing engagement structure between the dental implant and the alveolar bone.

A further object of this invention is to provide a dental implant which can prohibit bacteria from going deep into the alveolar bone along threads and thus prevent from periodontal disease.

Another object of this invention is to provide a dental implant whose abutment is made of shape memory alloy for easily adjusting the direction of the abutment without reducing the support strength of the abutment.

Additional features and advantages of the present invention will be set forth in the description which follows, and in portion will be apparent from the description, or may be learned by practice of the present invention. The objectives and advantages of the present invention will be realized and attained by the structure as particularly set forth in the written description and claims as well as illustrated in the appended drawings.

To achieve these and other advantages and according to the purpose of this invention, as embodied and broadly described, a dental implant able to enhance stability is provided. The dental implant of this invention defines a longitudinal axis and comprises: a first threaded section having a first diameter which decreases toward a free end of the first threaded section along the longitudinal axis; a second threaded section connected with the first threaded section and having a second diameter larger than the first diameter; a cut-in section obliquely extending from one end, away from the first threaded section, of the second threaded section outwards and having an integral tip with a feature of sharpness wherein the tip has an ability to cut into an alveolar bone of a patent while the dental implant is moved into the alveolar bone by rotating the first threaded section and the second threaded section; and a head section connected with the cut-in section for receiving a force to facilitate the dental implant to move into the alveolar bone.

In a preferred aspect, the dental implant of this invention further comprises: an engagement section situated between the first threaded section and the second threaded section, and the engagement section further including a solid portion and a plurality ribs which are located on an outer peripheral surface of the solid portion wherein a space between the ribs is configured to receive ossein for increasing the stability of combination of the dental implant with the alveolar bone.

Moreover, the cut-in section is a circle of sharp flange or a plurality of sharp flanges which are spaced apart.

It is another preferred feature that the head section includes an abutment for mounting an artificial crown thereon or for combining a function of receiving the force to implant the dental implant into the alveolar bone.

Additionally, the abutment and the second threaded section are two parts which are separately manufactured or are integrally made of a same material.

Furthermore, the head section includes a bolt head connected with the cut-in section and the abutment is connected to an end face, away from the second threaded section, of the bolt head.

It is preferred that the abutment are fastened to the second threaded section by means of a process of a laser welding, an electron-beam welding, a bolt-and-hole or an adhesive when the abutment and the second threaded section are two parts separately manufactured.

It is preferred that the engagement section has a third diameter which is smaller than the first diameter and the second diameter.

It is preferred that the cut-in section has a first width which is smaller than a second width of an artificial crown.

It is to be understood that both the foregoing general description and the following detailed description are exemplary and explanatory and are intended to provide a further non-limiting explanation of the present invention as claimed.

### BRIEF DESCRIPTION OF THE DRAWINGS

The accompanying drawings, which are included to provide a further understanding of the present invention and constitute a portion of the specification, illustrate embodiments of the present invention and together with the description serve to explain the principle of the present invention. In the drawings:

FIG. 1 is a front view of the dental implant according to the first embodiment of this invention illustrating that a head section just includes a bolt head;

FIG. 2 is a front view of the dental implant according to the second embodiment of this invention illustrating a head section just includes an abutment but the abutment combines the function of bolt head;

FIG. 3 is a front view of the dental implant according to the third embodiment of this invention illustrating a head section includes a bolt head and an abutment;

FIG. 4 is a sectional view of FIG. 3 illustrating the embodiment of one-pieced dental implant;

FIG. 5 is a sectional view of FIG. 3 illustrating the embodiment of two-pieced dental implant; and

FIG. 6 is a sectional view illustrating the third embodiment in which the dental implant is implanted into an alveolar bone and an artificial crown is mounted thereon.

### DETAILED DESCRIPTION OF THE PRESENT INVENTION

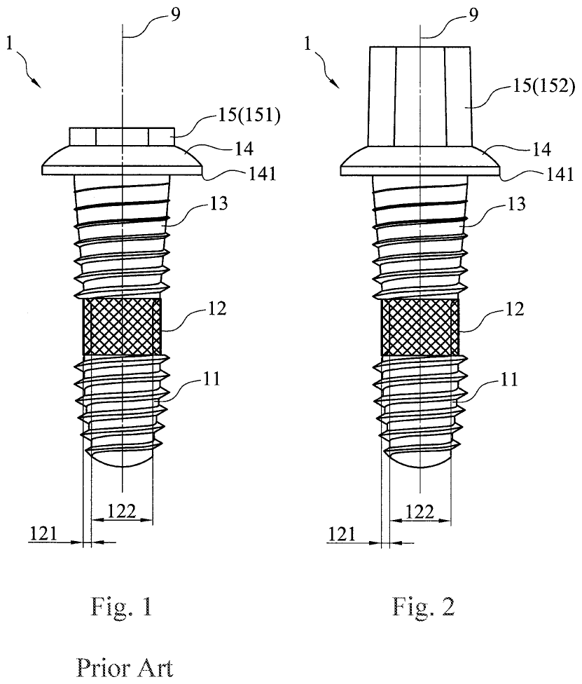

As shown in FIG. 1, the dental implant 1 which is able to enhance stability according to the first preferred embodiment of this invention is substantially a rod constituted by a plurality sections with different profiles, width or diameters. The sections are, in order, a first threaded section 11, engagement section 12, second threaded section 13, cut-in section 14 and head section 15.

Both the first threaded section 11 and second threaded section 13 are similar to a machine bolt or self-tapping screw but the threads surrounding the sections may or may not have cutting ability. Diameters of the first threaded section 11 and second threaded section 13 may gradually decrease or maintain unchanged along a longitudinal axis 9 of the dental implant 1 from the cut-in section 14 to the free end of the first threaded section 11. In a preferred embodiment, the second diameter of the second threaded section 13 is larger than the first diameter of the first threaded section 11. The first diameter of the first threaded section 11 gradually decreases toward the free end of the first threaded section 11 along a longitudinal axis 9 to facilitate insertion of the dental implant 1 into a bore 21 on the alveolar bone 2 (FIG. 6) in a dental implant surgery.

The engagement section 12 is situated between the first threaded section 11 and second threaded section 13. The engagement section 12 includes a solid portion 121 and a rib portion 122 which is located on outer peripheral surface of the solid portion 121. The rib portion 122 is constituted by a plurality of ribs which are spaced apart but preferably intersect with each other to form a hollowed-out and meshed structure. The diameter of the rib portion 122 is the same as or slightly smaller than the largest diameter of the first threaded section 11. In another preferred embodiment, the engagement section 12 may be omitted to make the second threaded section 13 directly connect to the first threaded section 11.

The profile of the cut-in section 14 is in a form of an umbrella. Specifically, the cut-in section 14 may be a circular flange which integrally extends from one end, away from the first threaded section 11, of the second threaded section 13 obliquely toward the first threaded section 11. The tip 141 of the flange has the feature of sharpness so that the sharp tip 141 of the cut-in section 14 can cut into the alveolar bone 2 (FIG. 6) to enhance stability of the dental implant 1 when the dental implant 1 is moved into the alveolar bone 2 by rotating the first threaded section 11 and second rotating section 13 in a dental implant surgery. The cut-in section 14 is not limited to a whole circle of forgoing flange shown in drawings. In other words, the cut-in section 14 may be composed of a plurality of sharp blades/flanges which are situated in a periphery and spaced apart. The size of the sharp flange is about 1 to 1.5 mm along the longitudinal axis 9. Preferably, the sharp tip 141 may be a vertical extension at the end of the arc of the cut-in section 14 shown in FIG. 6.

The head section 15 is located at one end, away from the first threaded section 11, of the cut-in section 14. The head section 15 may have a hexagonal, tetragonal or other geometric profile of a bolt head 151 to cooperate with an open-end wrench for rotating the dental implant 1 into the alveolar bone 2 (FIG. 6). In another embodiment, the head section 15 may be formed with a socket (not shown) to cooperate with a screwdriver or hex wrench for rotating the dental implant 1 into the alveolar bone 2. The two embodiments described in this paragraph are the head section 15 of the artificial tooth root of the two-pieced dental implant 1.

The length of the head section 15 shown in FIG. 2 is longer than that of the head section 15 shown in FIG. 1. Accordingly, the head section shown in FIG. 2 may also function as the abutment 152 for mounting the artificial crown 3 thereon except functioning as the bolt head 151 for cooperating with the open-end wrench to rotate the dental implant 1 into the alveolar bone 2. The embodiments described in this paragraph are the head section 15 of the one-pieced dental implant 1.

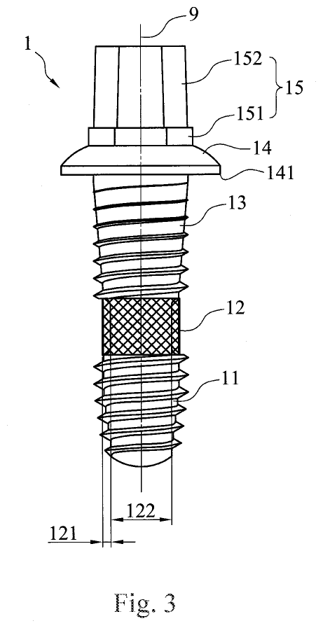

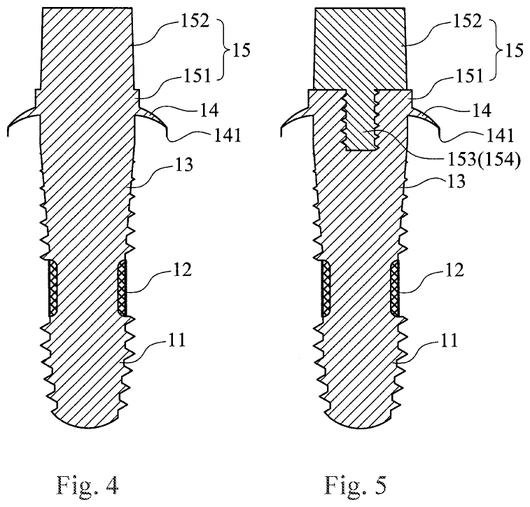

As shown in FIGS. 3 and 4, the head section 15 may include the bolt head 151 connected to the cut-in section 14 and the abutment 152 connected to the bolt head 151. The profile of the bolt head 151 may be the same as or different from that of the abutment 152. The width of the bolt head 151 may also be the same as or different from that of the abutment 152. The width of the abutment 152 may be larger than that of the second threaded section 13 but smaller than that of the cut-in section 14. The embodiments described in this paragraph are the head section 15 of the one-pieced dental implant 1.

The abutment 152 in forgoing embodiments may be slightly tapped to facilitate assembly of the artificial crown 3. In the embodiments of the one-pieced dental implant 1, the whole implant, from the first threaded section 11 to the abutment 152 of the head section 15, is integrally made of the same material, such as titanium or titanium alloy.

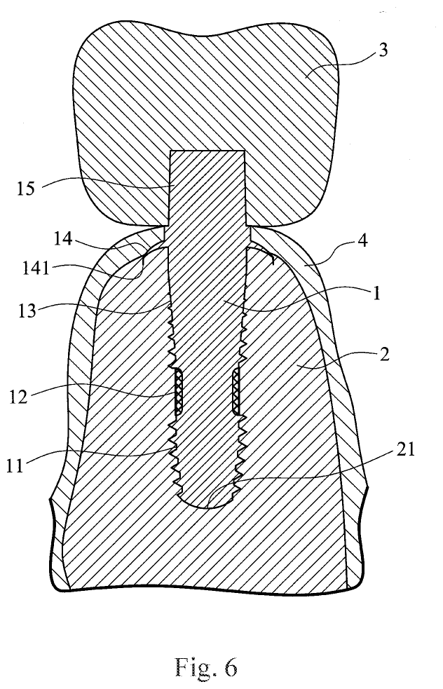

As for embodiments of the two-pieced dental implant 1 shown in FIG. 5, the dental implant 1 comprises an abutment 152 and a sub-component both of which are separately manufactured. The sub-component includes the bolt head 151, cut-in section 14, second threaded section 13, engagement section 12 and first threaded section 11 mentioned in forgoing embodiments.

In an embodiment, the abutment 152 may be welded onto the bolt head 151 or the cut-in section 14 (for the embodiment in which the abutment 152 also functions as the bolt head 151) by the process of laser welding or electron-beam welding.

In another embodiment, the abutment 152 may be provided with a threaded bolt 153 extending outwards from the center of one of its end faces. The sub-component is formed with a threaded hole 154 extending from the end face of the bolt head 151 or the end face of the cut-in section 14 (for the embodiment in which the abutment 152 also functions as the bolt head 151) toward the interior of the second threaded section 13. By rotating the threaded bolt 153 into the threaded hole 154, the abutment 152 which is separately manufactured is assembled to the sub-component to complete the two-pieced dental implant 1.

In yet another embodiment, the abutment 152 which is separately manufactured is firmly adhered to the sub-component by means of adhesive. The adhesive may be also applied to the position between the threaded bolt 153 and the threaded hole 154 to strengthen fixation between the abutment 152 and the sub-component. The adhesive may be glass ionomer cement, composite cement, resin cement or other proper adhesives.

In the embodiment of two-pieced dental implant 1, the sub-component may be made of titanium or titanium alloy while the abutment 152 may be made of shape memory alloy such as nitinol. After the abutment 152 is assembled to the sub-component, the orientation of the abutment 152 made of shape memory alloy may be changed due to variation of temperature. By changing the direction of the abutment 152, the abutment 152 may be adjusted to face opposite tooth so as to allow the artificial crown 3 biting the opposite tooth and align the whole dental implant 1 with adjacent teeth.

### EFFECTS

As shown in FIG. 6, after the dental implant 1 of this invention is implanted into the alveolar bone 2, because the sharp tip 141 of the cut-in section 14 penetrate into the alveolar bone 2 (and the gum 4), contact positions or points between the dental implant 1 and the alveolar bone 2 are increased. Specifically, the dental implant 1 of this invention has additional contact positions between the sharp tip 141 and the alveolar bone 2 except the threads on the first threaded section 11 and the second threaded section 13. Besides, the additional contact positions are far away from the threads so that preliminary and long-term stability of the dental implant 1 can be dramatically enhanced.

On the other hand, because the sharp tip 141 goes deep into the alveolar bone 2 by a certain depth, the sharp tip 141 itself also increases contact area between the dental implant 1 and the alveolar bone 2. Such an advantage can also enhance preliminary and long-term stability of the dental implant 1.

Next, during osseous integration, ossein will grow through the hollowed-out structure constituted by ribs in the engagement section 12 to combine the newly-growing ossein with the dental implant 1 together. Therefore, long-term stability for the combination of the dental implant 1 and the alveolar bone 2 can be increased.

Furthermore, dental bone graft material may be put into the hollowed-out structure in the engagement section 12 in advance and then the dental implant 1 is implanted into the alveolar bone 2. The bone graft material may speed up the osseous integration and guide the ossein into the hollowed-out structure. Hence, long-term stability of the dental implant 1 can be also increased.

Moreover, engagement of newly-growing ossein with the hollowed-out structure of the dental implant 1 blocks continuity from the second threaded section 13 to the first threaded section 11. The engagement can prohibit bacteria from going deep into the interior of the alveolar bone 2 along the threads and thus prevent from periodontal disease.

Besides, the abutment 152 made of shape memory alloy is helpful for adjusting the direction of the artificial crown 3 to align it with other teeth. Hence, aesthetic appearance can be obtained from the dental implant surgery without reducing the support strength of the abutment 152.

Summing up, the dental implant 1 of this invention can achieve objects of this invention. This invention has been disclosed in terms of specific embodiments. It will be apparent that many modifications can be made to the disclosed structures without departing from the present invention. Therefore, it is the intent of the appended claims to cover all such variations and modifications that are within the scope of this invention.

What is claimed is:

1. A dental implant able to enhance stability, the dental implant defining a longitudinal axis and comprising:
a first threaded section having a first diameter which decreases toward a free end of the first threaded section along the longitudinal axis;
a second threaded section connected with the first threaded section and having a second diameter larger than the first diameter;
a cut-in section obliquely extending from one end, away from the first threaded section, of the second threaded section outwards and having an integral tip with a feature of sharpness wherein the tip has an ability to cut into an alveolar bone of a patent while the dental implant is moved into the alveolar bone by rotating the first threaded section and the second threaded section; and
a head section connected with the cut-in section for receiving a force to facilitate the dental implant to move into the alveolar bone.

2. The dental implant able to enhance stability according to the claim 1, further comprising:
an engagement section situated between the first threaded section and the second threaded section, and the engagement section further including a solid portion and a plurality ribs which are located on an outer peripheral surface of the solid portion wherein a space between the ribs is configured to receive ossein for increasing the stability of combination of the dental implant with the alveolar bone.

3. The dental implant able to enhance stability according to the claim 2, wherein the cut-in section is a circle of sharp flange or a plurality of sharp flanges which are spaced apart.

4. The dental implant able to enhance stability according to the claim 3, wherein the head section includes an abutment for mounting an artificial crown thereon or for combining a function of receiving the force to implant the dental implant into the alveolar bone.

5. The dental implant able to enhance stability according to the claim 4, wherein the abutment and the second threaded section are two parts which are separately manufactured or are integrally made of a same material.

6. The dental implant able to enhance stability according to the claim 5, wherein the head section includes a bolt head connected with the cut-in section and the abutment is connected to an end face, away from the second threaded section, of the bolt head.

7. The dental implant able to enhance stability according to the claim 6, wherein the abutment are fastened to the second threaded section by means of a process of a laser welding, an electron-beam welding, a bolt-and-hole or an adhesive when the abutment and the second threaded section are two parts separately manufactured.

8. The dental implant able to enhance stability according to the claim 2, wherein the engagement section has a third diameter which is smaller than the first diameter and the second diameter.

9. The dental implant able to enhance stability according to the claim 8, wherein the cut-in section has a first width which is smaller than a second width of an artificial crown.

10. The dental implant able to enhance stability according to the claim 1, wherein the cut-in section is a circle of sharp flange or a plurality of sharp flanges which are spaced apart.

11. The dental implant able to enhance stability according to the claim 10, wherein the head section includes an abutment for mounting an artificial crown thereon or for combining a function of receiving the force to implant the dental implant into the alveolar bone.

12. The dental implant able to enhance stability according to the claim 11, wherein the abutment and the second threaded section are two parts which are separately manufactured or are integrally made of a same material.

13. The dental implant able to enhance stability according to the claim 12, wherein the head section includes a bolt head connected with the cut-in section and the abutment is connected to an end face, away from the second threaded section, of the bolt head.

14. The dental implant able to enhance stability according to the claim 13, wherein the abutment are fastened to the second threaded section by means of a process of a laser welding, an electron-beam welding, a bolt-and-hole or an adhesive when the abutment and the second threaded section are two parts separately manufactured.
